(19) United States
(12) Patent Application Publication
(10) Pub. No.: US 2025/0246676 A1
(43) Pub. Date: Jul. 31, 2025

(54) SOLID ELECTROLYTE FILM

(71) Applicant: UCL BUSINESS LTD, London, Greater London (GB)

(72) Inventors: Pooja VADHVA, London, Greater London (GB); Alexander RETTIE, London, Greater London (GB); Thomas GILL, London, Greater London (GB)

(21) Appl. No.: 18/853,985

(22) PCT Filed: Apr. 3, 2023
(86) PCT No.: PCT/GB2023/050883

§ 371 Date: Oct. 3, 2024

(30) Foreign Application Priority Data
Apr. 4, 2022 (GB) 2204894.6

(51) Int. Cl. H01M 10/0562; H01M 10/0525

(52) U.S. Cl. CPC H01M 10/0562; H01M 10/0525; H01M 2300/0071

(57) ABSTRACT

A method is provided for forming a lithium aluminium oxide phosphate (LAPO) solid electrolyte film. The comprises: depositing an aqueous precursor solution onto a substrate to form a deposited film; and annealing the deposited film to form the LAPO solid electrolyte film. The precursor solution contains lithium and aluminium in a molar ratio of at least 2.6:1.

### FIELD OF THE INVENTION

The invention relates to solid inorganic electrolyte films, in particular to methods for forming lithium aluminium oxide phosphate (LAPO) solid electrolyte films.

### BACKGROUND

Over the past few decades, lithium-ion battery (LIB) technology has held a dominant position in a wide range of applications, principally: portable electronic devices, wearable devices, electric vehicles, and grid storage. However, with LIBs reaching their maturity, a new generation of advanced batteries with increased energy and power densities are expected to be deployed.

Lithium metal anodes have a theoretical energy density approximately ten times that of the graphite anodes used in LIBs. Also, the traditional liquid electrolytes used in LIBs are not able to supress dendrite formation while solid electrolytes (SEs) are believed to be able to block dendrite propagation due to their mechanical rigidity and high transference number. However, for practical commercialisation there are stringent SE material requirements: high ionic conductivity with stability against Li-metal, mechanical toughness, low interfacial resistance achieved by wettability at the electrode surface, reduction in grain boundaries and electronic conductivity as well as ease of manufacturing at scale.

Non-crystalline materials (NCMs) have emerged as a potential candidate to meet these stringent requirements. One of these NCMs, lithium phosphorus oxynitride (LiPON), has demonstrated a high cycle life in a thin-film solid-state battery (SSB) due to its ability to block dendrite propagation and is currently the only commercial SSB SE. Its uses in thin-film micro-batteries include portable electronics, internet of things (IoT) and medical devices. In addition, the stability of LiPON against Li-metal enables its use as a Li-anode protection coating in lithium metal batteries such as: lithium sulphur (Li—S) and lithium air chemistries. Furthermore, LiPON's glassy, amorphous nature eliminates grain boundaries which act as sites for lithium dendrite growth. In combination with LiPON's low electronic conductivity, its excellent ability to block lithium penetration can be elucidated. However, due to the costly and slow vacuum deposition method used to form LiPON thin films, the scalability of LiPON to bulk SSBs is restricted.

Other lithium-containing glassy oxides which exhibit similar properties to LiPON in addition to being highly scalable are therefore being explored as possible candidates for applications in thin-film micro-batteries. Solution processing methods involving direct deposition of precursor solutions followed by an annealing step at moderate temperatures can provide an alternate and highly scalable route for synthesising SEs. This approach is sometimes referred to as prompt inorganic condensation (PIC), and has been used to synthesise lithium aluminium oxide phosphate (LAPO) solid electrolyte films, which show promise as candidates for applications in thin-film micro-batteries (see Clayton et al., Low-temperature fabrication of lithium aluminum oxide phosphate solid electrolyte thin films from aqueous precursors, RSC Adv., 2017, 7, 7046). Solution-processing methods for NCMs can reduce the cost of manufacturing and realize the commercialisation of SSBs by providing a cost-effective and scalable means of synthesising thin films of inorganic solid electrolytes. However, the ionic conductivities so far reported by Clayton et al. for LAPO films synthesised by PIC fall short of the requirements for SSBs.

There is therefore a need for improved solution-based methods for synthesising thin-film NCMs for use as SEs that are practical, scalable, cost-effective, and provide thin-film SEs meeting the requirements of SSBs, namely a high ionic conductivity, a low electronic conductivity, and a glassy or amorphous structure that eliminates grain boundaries and supresses lithium dendrite growth, together with thin-film SEs meeting these requirements. Such thin-film SEs may be used in SSBs or as thin film SEs in other types of battery, for example as protective coatings for positive or negative electrode materials in lithium-ion batteries.

### SUMMARY OF THE INVENTION

The invention is defined by the claims, which are to be construed taking due account of elements that are equivalent to the elements specified in the claims.

According to a first aspect, the invention provides a method for forming a lithium aluminium oxide phosphate (LAPO) solid electrolyte film. The method comprises depositing an aqueous precursor solution onto a substrate to form a deposited film. The aqueous precursor solution may comprise an aluminium-containing precursor, a lithium-containing precursor, and a phosphate-containing precursor. The method further comprises annealing the deposited film to form the LAPO solid electrolyte film. The precursor solution may contain lithium and aluminium in a molar ratio of at least 2.6:1 (Li:Al).

Depositing the aqueous precursor solution onto the substrate to form the deposited film may comprise spin coating the aqueous precursor solution on the substrate to form the deposited film.

The molar ratio of lithium to aluminium in the precursor solution may be at least 2.7:1. The molar ratio of lithium to aluminium in the precursor solution may be no greater than 2.9:1. The molar ratio of lithium to aluminium in the precursor solution may be no greater than 2.90:1. The molar ratio of lithium to aluminium in the precursor solution may be no greater than 2.8:1.

The molar ratio of lithium to aluminium in the precursor solution may be within the range of 2.6:1 to 2.9:1. The molar ratio of lithium to aluminium in the precursor solution may be within the range of 2.7:1 to 2.8:1.

The precursor solution may contain phosphate (or phosphorous, P) and aluminium in a molar ratio of 1.40:1 or less, preferably 1.35:1 or less, even more preferably 1.30:1 or less.

The precursor solution may contain phosphate (or phosphorous, P) and aluminium in a molar ratio of at least 1.10:1, preferably at least 1.15:1, further preferably at least 1.20:1.

The ratio of phosphate to aluminium in the precursor solution may be within the range of 1.10:1 to 1.40:1, 1.15:1 to 1.35:1, 1.15:1 to 1.30:1 or 1.20:1 to 1.30:1.

The annealing of the deposited film may be carried out at a temperature of less than 250° C. The annealing of the deposited film may be carried out at a temperature of less than 240° C.

The annealing of the deposited film may be carried out at a temperature of at least 220° C. The annealing of the deposited film may be carried out at a temperature of at least 225° C. The annealing of the deposited film may be carried out at a temperature of at least 230° C.

The annealing of the deposited film may be carried out at a temperature of at least 220° C. and less than 250° C. The annealing of the deposited film may be carried out at a temperature of at least 230° C. and less than 240° C.

The annealing of the deposited film may be performed for a duration of at least 45 minutes. The annealing of the deposited film may be performed for a duration of at least about an hour.

The LAPO solid electrolyte film may be an amorphous/glassy/non-crystalline film.

The LAPO solid electrolyte film may have an ionic conductivity of at least 8×10⁻⁸ S cm⁻¹, preferably at least 1×10⁻⁷ S cm⁻¹.

The LAPO solid electrolyte film may have an ionic conductivity activation energy of less than 0.6 eV, preferably less than 0.5 eV.

The LAPO solid electrolyte film may contain lithium and aluminium in a molar ratio of at least 2.6:1. The LAPO solid electrolyte film may contain lithium and aluminium in a molar ratio of at least 2.7:1.

The LAPO solid electrolyte film may contain lithium and aluminium in a molar ratio of no greater than 3.2:1. The LAPO solid electrolyte film may contain lithium and aluminium in a molar ratio of no greater than 3.0:1. The LAPO solid electrolyte film may contain lithium and aluminium in a molar ratio of no greater than 2.9:1.

The aluminium-containing precursor may be aluminium nitrate and/or aluminium hydroxide.

The lithium-containing precursor may be lithium nitrate.

The phosphate-containing precursor may be phosphoric acid.

The ratio of phosphate to aluminium in the precursor solution may be about 3:2.

The LAPO solid electrolyte film may have a thickness of 1 μm or less. The LAPO solid electrolyte film may have a thickness of less than 1 μm or less than 500 nm.

The method may comprise curing the deposited film by heating the deposited film prior to annealing the deposited film.

The temperature to which the deposited film is heated during the curing may be less than 250° C. The temperature to which the deposited film is heated during the curing may be less than 240° C.

The temperature to which the deposited film is heated during the curing may be no higher than the temperature to which the deposited film is heated during the annealing.

During the method, the deposited film may never reach a temperature of 250° C. During the method, the deposited film may never reach a temperature of 240° C.

According to a second aspect, the invention provides a lithium aluminium oxide phosphate (LAPO) solid electrolyte film formed by the method of any preceding claim.

According to a third aspect, the invention provides lithium aluminium oxide phosphate (LAPO) solid electrolyte film containing lithium and aluminium in a molar ratio of at least 2.6:1.

The LAPO solid electrolyte film may have any of the properties described in relation to the LAPO film formed by the method of the first aspect of the invention.

According to a fourth aspect, the invention provides an electric battery comprising an LAPO solid electrolyte film as described above.

The LAPO solid electrolyte film may be present in the battery as an electrolyte or as an electrode protective layer on an anode and/or cathode of the battery.

The battery may, for example, be a solid-state battery. The LAPO solid electrolyte film may be present as the electrolyte in the solid-state battery. In other words, the electrolyte of the solid-state battery may comprise the LAPO solid electrolyte film.

### BRIEF DESCRIPTION OF THE FIGURES

The invention will now be described, by way of example only, with reference to the accompanying drawings, in which:

FIG. 1 shows a flowchart illustrating a method in accordance with the invention.

FIG. 2a shows a cross-sectional SEM image of an LAPO film on a silicone substrate.

FIG. 2b shows top-down views obtained using AFM of single-layer LAPO films annealed at temperatures of (from left to right) 230° C., 275° C., 350° C. and 400° C.

FIG. 2c shows a plot of average surface roughness and (Ra) of the LAPO films of FIG. 2b as a function of annealing temperature.

FIG. 3 shows theta-theta XRD data for LAPO films annealed at 230, 275, 350, 400 and 550° C. No detectable signal from the films is seen against the fused silica scan substrate highlighting the amorphous or only short-range order in the films.

FIG. 4 shows XPS region plots of LAPO films annealed at 275° C. for Li 1s, O 1s, P 2p and Al 2p scans.

FIG. 5a shows a plot of the measured ionic conductivity of LAPO films as a function of the Li:Al molar ratio of the films, as determined by XPS. All films were annealed at 275° C.

FIG. 5b shows a plot of the measured ionic conductivity of LAPO films as a function of the P:Al molar ratio in the precursor solution. All films were annealed at 275° C.

FIG. 6 shows a Nyquist spectrum of an LAPO film annealed at 275° C. with the ECM fit displayed and the ECM inset in the figure.

FIG. 7 shows a plot of ionic conductivity as a function of annealing temperature for LAPO films synthesised using a precursor solution having a Li:Al molar ratio of 2.75:1.

FIG. 8 shows current-voltage decay curves for LAPO films annealed at different temperatures. A DC bias of 1 V was applied in all cases.

FIG. 9 shows a plot of the natural logarithm of the ionic conductivity multiplied by T against 1/T for an LAPO film synthesised using a precursor solution having a Li:Al ratio of 2.75:1 and annealed at 275° C.

### DETAILED DESCRIPTION

The following description is intended to introduce various aspects and features of the invention in a non-limiting manner. For clarity and brevity, features and aspects of the invention may be described in the context of particular embodiments. However, it should be understood that features of the invention that are described only in the context of one or more embodiments may be employed in the invention in the absence of other features of those embodiments, particularly where there is no inextricable functional interaction between those features. Even where some functional interaction between the features of an embodiment is discernible, it is to be understood that those features are not inextricably linked if the embodiment would still fulfil the requirements of the invention without one or more of those features being present. Thus, where features are, for brevity, described in the context of a single embodiment, those features may also be provided separately or in any suitable sub-combination. It should also be noted that features that are described in the context of separate aspects and embodiments of the invention may be used together and/or be interchangeable wherever possible. It is also to be understood that all disclosed optional features, values and ranges may be combined with any other optional features, values and ranges in any suitable combination, and it should therefore be understood that all such combinations are therefore disclosed. For example, individual features may be extracted from a plurality of lists of features and combined, and all such combinations are to be understood to be disclosed herein.

Features described in connection with the invention in different contexts (e.g. method, product, etc.) may each have corresponding features definable and/or combinable with respect to each other, and these embodiments are specifically envisaged. Where methods are disclosed, it should be understood that the products of said methods are also specifically disclosed. Where products are disclosed, it should be understood that the methods of making/forming/synthesising them are also disclosed, as are any uses or methods of using of said products. Where the term “comprise” is used, this should also be understood to include “consists of” or “consists essentially of” unless the context implies otherwise. Where the term “consists of” is used, this should be understood to also include “consists essentially of”. Where numerical values or ranges are disclosed, it should be understood that, even where not specifically mentioned, these values may be prefixed by “about” or “approximately”.

The invention provides a method for synthesising lithium aluminium oxide phosphate (LAPO or Li—Al—P—O) solid electrolyte films. The method that is employed involves preparing an aqueous precursor solution comprising precursor substances, depositing the precursor solution on a substrate to form a thin film, for example by spin-coating the precursor solution on the substrate, and then annealing the thin film at an elevated temperature to form a lithium aluminium oxide phosphate (LAPO) solid electrolyte film. Such an approach is sometimes referred to as prompt inorganic condensation (PIC) in the literature, although the method of the invention is not necessarily limited to the restrictions of any such terminology.

The inventors have discovered that two factors result in a noticeably improved (i.e. higher) ionic conductivity of the resulting films than has been previously reported, a crucial property for solid electrolytes. The first modification is the use of a lithium to aluminium (Li:Al) ratio in the precursor solution in excess of the known stoichiometry of LAPO, e.g. using a Li:Al ratio of at least 2.6:1. The second modification is the use of lower annealing temperatures, e.g. less than 250° C. Both of these modifications improve the ionic conductivity of the resulting LAPO films, and can be employed either separately or together in the method of the invention.

The effect of synthesis conditions and material stoichiometry on ionic conductivity for non-crystalline materials (NCMs) is non-trivial. The structure and properties of these materials are complex, and ionic conduction in NCMs is poorly understood. The findings by the inventors are therefore surprising and provide novel means of preparing LAPO solid electrolyte films having superior properties and which are suitable for use as SEs in SSBs.

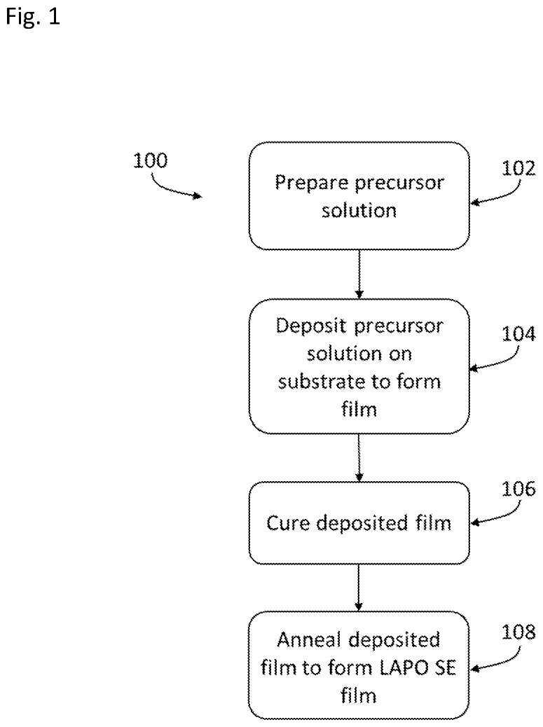

Referring to FIG. 1, a method 100 in accordance with the invention may involve step 102 of preparing an aqueous precursor solution. The aqueous precursor solution comprises a source of lithium (e.g. a source of lithium ions), a source of aluminium (e.g. a source of aluminium ions) and a source of phosphate (e.g. a source of phosphate ions). The aqueous precursor solution therefore generally comprises at least one lithium-containing precursor, at least one aluminium-containing precursor, and at least one phosphate-containing precursor. The precursor substances may be dissolved in water to form the aqueous precursor solution. In particular, the precursor substances may each be dissolved substantially completely in the precursor solution. In other words, the precursor substances may be fully dissolved in water to form the aqueous precursor solution.

The lithium-containing precursor may be lithium nitrate (LiNO₃). The aluminium-containing precursor may be aluminium nitrate (Al(NO₃)₃) or aluminium hydroxide (Al(OH)₃). If the aluminium-containing precursor is aluminium hydroxide nitric acid may be added to the precursor solution to facilitate dissolution of the aluminium hydroxide. The phosphate-containing precursor may be phosphoric acid (H₃PO₄).

The precursor substances may be mixed together in water until they are substantially completely dissolved to form the precursor solution. The concentration of the precursor solution with respect to aluminium may be in the range of 0.1 M to 1 M, for example 0.2 M to 0.6 M. In particular, the concentration of the precursor solution with respect to aluminium may be about 0.4 M.

In previous studies, the molar ratios of lithium, aluminium and phosphorus in the precursor solution have been set equal to the stoichiometric ratios found in LAPO, which typically has a chemical formula of LisAl₂O(PO₄)₃. In particular, the molar ratios reported by Clayton et al. were 1.5:1:2.5 with respect to P:Al:Li. However, the inventors have discovered that using a stoichiometric excess of lithium in the precursor solution results in LAPO films that have an improved ionic conductivity compared to using a stoichiometric ratio of lithium to aluminium. Therefore, the molar ratio of lithium to aluminium in the precursor solution is preferably at least 2.6:1, further preferably at least 2.7:1. Particularly good ionic conductivity properties are achieved when the lithium to aluminium ratio in the precursor solution is about 2.75:1, and the lithium to aluminium ratio may in the precursor solution may therefore be about 2.75:1. At higher Li:Al molar ratios of 3:1 or above, lithium is not incorporated into the LAPO film as readily, and the films do not spin coat as well, which can, counterintuitively, actually result in a lower amount of lithium in the final film. Therefore, it is preferable for the molar ratio of Li:Al in the precursor solution to be no greater than 2.9:1, preferably no greater than 2.90:1, and further preferably no greater than 2.8:1. It is within these upper and lower bounds that particularly high ratios of lithium are incorporated into the final LAPO film, which increases the ionic conductivity. The ratio of lithium to aluminium in the precursor solution may therefore be within the range of 2.6:1 to 2.9:1 (or 2.90:1), 2.6:1 to 2.8:1, or 2.7:1 to 2.8:1. However, any of the aforementioned lower and upper bounds may be combined to provide other suitable ranges.

The inventors have also discovered that using a molar ratio of phosphate (or phosphorous, P, which is equivalent in molar amounts) to aluminium in precursor solution that is lower than the stoichiometric ratio of 1.5:1 typically found in LAPO results in LAPO films that have an improved ionic conductivity. Therefore, the molar ratio of phosphate to aluminium in the precursor solution is preferably 1.40:1 or less, further preferably 1.35:1 or less, even more preferably 1.30:1 or less. Particularly good ionic conductivity properties are achieved when the phosphate to aluminium ratio in the precursor solution is about 1.25:1, and the lithium to aluminium ratio may in the precursor solution may therefore be about 1.25:1. The LAPO films form best and have the highest ionic conductivities when the molar ratio of phosphate to aluminium in the precursor solution is at least 1.10:1, preferably at least 1.15:1, further preferably at least 1.20:1. The ratio of phosphate to aluminium in the precursor solution may therefore be within the range of 1.10:1 to 1.40:1, 1.15:1 to 1.35:1, 1.15:1 to 1.30:1 or 1.20:1 to 1.30:1. However, any of the aforementioned lower and upper bounds may be combined to provide other suitable ranges.

Since the precursor substances are substantially completely dissolved in the precursor solution, the molar ratio of lithium to aluminium in the precursor solution may be adjusted as required by adjusting the amounts of the precursor substances added to the precursor solution. For example, when the lithium-containing precursor is lithium nitrate and the aluminium-containing precursor is aluminium nitrate or aluminium hydroxide the lithium precursor and the aluminium precursor may be added to, or be present in, the precursor solution in the molar ratios mentioned above in order to yield the required molar ratios of lithium to aluminium in the precursor solution. More generally, since the aluminium, lithium and phosphate are provided from the aluminium-containing precursor(s), lithium-containing precursor(s) and phosphate-containing precursor(s), respectively, the precursor solution may contain aluminium-containing precursor(s), lithium-containing precursor(s) and phosphate-containing precursor(s) in the molar ratios described above with respect to aluminium, lithium and phosphate, respectively. For example, the total molar ratio of the lithium-containing precursors to the total molar amount of the aluminium-containing precursors in the precursor solution is preferably at least 2.6:1 and preferably no greater than 2.9:1. Similarly, the total molar ratio of the phosphorous-containing precursors to the total molar amount of the aluminium-containing precursors in the precursor solution is preferably 1.40:1 or less and preferably at least 1.10:1.

Referring again to FIG. 1, method 100 involves step 104 of depositing the aqueous precursor solution on a substrate to form a thin film. The thin film generally has a thickness of 1 μm or less when deposited and spread on the substrate. Step 104 typically comprises spin coating the aqueous precursor solution on the substrate to form a spin-coated film. During the spin-coating step the substrate may be spun at approximately 3000 rpm for approximately 30 seconds to spread the precursor solution across the surface of the substrate to form the thin film. Although spin coating has been described, the deposited film may be formed by other means capable of forming a thin film on the substrate from the precursor solution.

The substrate may be a silicon substrate, such as a boron-doped silicone substrate. However, other substrates may be used, and the nature of the substrate will depend on the application for which the LAPO film is intended. The substrate may be cleaned prior to depositing the precursor solution onto the substrate. For example, the substrate may be sonicated in one or more solvents such as acetone and isopropyl alcohol (IPA), with the substrate rinsed with water between sonication in each of the solvents. The substrate may then be dried, for example using nitrogen gas. The substrate may be treated by oxygen plasma cleaning to produce a hydrophilic surface, optionally after the cleaning process described above.

Once the precursor solution has been deposited onto the substrate to form a thin film in step 104, the deposited film may optionally be cured in step 106. This initial curing step may involve heating the thin film (and the substrate). For example, the thin film may be heated for a short period of time, for example for a time in the range of 30 seconds to 2 minutes, for example for about 1 minute. The temperature to which the film is heated in the curing step is generally sufficient to cure the film, i.e. to remove sufficient water from the film to immobilise it on the substrate. The curing step therefore generally involves heating the film to a temperature of at least 200° C. The thin film is preferably heated to a temperature of less than 250° C., preferably less than 240° C., for example about 230° C. In particular, the film may be heated to a temperature of less than or equal to the temperature used in the subsequent annealing step.

The method may further comprise adding further layers to the film in a stepwise process. For example, once the first layer of the film has been initially formed onto the substrate and cured in steps 104 and 106, a further amount of the precursor solution may be deposited onto the cured film, spin coated (or otherwise formed into a film layer) and cured to build up the film in a stepwise manner. This process may be repeated until sufficient layers have been added to form a film of the desired thickness. Steps 104 and 106 may therefore form a first layer of the film, which is cured, before subsequent layers are deposited to form the final deposited film.

Once the deposited film has been formed (and optionally cured) on the substrate, the film is then annealed in step 108 by heating the film to an annealing temperature. The annealing process removes water and nitrate from the film and results in the formation of an LAPO solid electrolyte film. The annealing process therefore involves heating the film to a sufficient temperature, and for a sufficient length of time, to form an LAPO SE film. The inventors have discovered that it is not necessary to heat the films to the extent that was previously reported in order to form a stable LAPO film, and that the annealing process may be performed at a temperature of less than 250° C., or even less than 240° C. Moreover, at these lower annealing temperatures the ionic conductivity of the resulting LAPO film is improved. As reported in the following examples, excellent results have been obtained when annealing at a temperature of 230° C. The annealing of the deposited film may therefore be carried out at a temperature of less than 250° C. In other words, the deposited film may be annealed by heating the film to a temperature of less than 250° C. The annealing of the deposited film is preferably be carried out at a temperature of less than 240° C., for example at a temperature of about 230° C. To form the solid electrolyte film, the annealing may be carried out at a temperature of at least 220° C., or at least 225° C. For example, the annealing of the deposited film may be carried out at a temperature of at least 220° C. and less than 250° C., or at a temperature of at least 230° C. and less than 240° C. However, any of the aforementioned lower and upper temperature bounds may be combined to provide other suitable ranges for the annealing temperature.

The annealing of the deposited film is performed for a sufficient length of time to provide an LAPO solid electrolyte film, and may therefore be performed for a duration of at least 45 minutes, for example for at least about an hour. In other words, the film is heated to the annealing temperature for this period of time.

The resulting LAPO solid electrolyte films are amorphous, i.e. they are glassy, or substantially non-crystalline. The amorphous film structure avoids the localized current pathways that are associated with grain boundaries in crystalline materials.

The method is capable of producing LAPO films having a thickness of 1 μm or less, for example less than 500 nm, and is therefore a suitable means for preparing thin film solid electrolytes. In fact, the method can be tailored to provide LAPO solid electrolyte films having a thickness of 100 nm or less. The film thickness may be measured by scanning electron microscopy (SEM), for example from an SEM cross-sectional image of the film.

The resulting LAPO solid electrolyte film may have a stoichiometric ratio of lithium to aluminium of at least 2.6:1. In other words, the LAPO solid electrolyte film may contain lithium and aluminium in a molar ratio of at least 2.6:1. For example, the LAPO solid electrolyte film may have a stoichiometric ratio of lithium to aluminium of at least 2.7:1. Particularly high ionic conductivities have been measured for LAPO solid electrolyte films synthesised by the method of the invention having a molar ratio of lithium to aluminium of no greater than 3.2:1. The LAPO film may therefore contain lithium and aluminium in a molar ratio of no greater than 3.2:1, preferably no greater than 3.0:1, further preferably no greater than 2.9:1. The LAPO solid electrolyte film may therefore contain lithium and aluminium in a molar ratio in a range of from 2.6:1 to 3.2:1, 2.6:1 to 3.0:1; 2.7:1 to 3.0:1 or 2.7:1 to 2.9:1. However, any of the aforementioned lower and upper ratios of Li:Al in the LAPO film may be combined to provide other suitable ranges.

The resulting LAPO solid electrolyte film generally have a stoichiometric ratio of phosphate/phosphorous to aluminium that is the same as the ratio of aluminium to phosphate in the precursor solution. In other words, the LAPO solid electrolyte film may contain phosphorous and aluminium in any of the molar ratios described above in relation to the molar ratios of phosphorous and aluminium in the precursor solution. For example, the LAPO solid electrolyte film may contain phosphorous/phosphorous and aluminium in a molar ratio of 1.40:1 or lower, preferably 1.35:1 or lower, further preferably 1.30:1 or lower. Particularly good ionic conductivity properties are achieved when the phosphate/phosphorous to aluminium ratio in the LAPO film is about 1.25:1, and the lithium to aluminium ratio in the LAPO film may therefore be about 1.25:1. The LAPO films form best and have the highest ionic conductivities when the molar ratio of phosphate/phosphorous to aluminium in the film is at least 1.10:1, preferably at least 1.15:1, further preferably at least 1.20:1. The ratio of phosphate/phosphorous to aluminium in the LAPO film may therefore be within the range of 1.10:1 to 1.40:1, 1.15:1 to 1.35:1, 1.15:1 to 1.30:1 or 1.20:1 to 1.30:1. However, any of the aforementioned lower and upper bounds may be combined to provide other suitable ranges.

The various Li:Al and P:Al ratios set out above are preferably combined as this provides LAPO films with the highest ionic conductivities.

The film composition (e.g., amounts of Li, Al and P and the molar ratios of Li:Al and phosphatate/P:Al) may be measured by X-ray photoelectron spectroscopy (XPS).

The LAPO solid electrolyte films formed by the method of the invention have an ionic conductivity of at least (i.e. of greater than or equal to) 8×10⁻⁸ S cm⁻¹, and even of at least 1×10⁻⁷ S cm⁻¹, when measured at room temperature (i.e. 25° C.). The ionic conductivities may be measured using an alternating current, as described below, and may therefore be referred to as AC ionic conductivities. The ionic conductivity is measured by fitting an equivalent circuit model (ECM) to electrochemical impedance spectroscopy (EIS) measurements of the film. The equivalent circuit model comprises elementary components in a Randles'-type circuit, as described, for example in Lasia et al. (Definition of Impedance and Impedance of Electrical Circuits: Electrochemical Impedance Spectroscopy and its Applications: Springer New York: 2014. p. 7-66) and Westerhoff et al. (Analysis of Lithium-Ion Battery Models Based on Electrochemical Impedance Spectroscopy: Energy Technol. 2016, 4, 1620). The electrochemical impedance spectroscopy may be conducted using a 5 mV perturbation voltage over a frequency range of 50 Hz to 1 MHz. Electrical contacts may be formed on the top side of the LAPO film in order to perform the electrochemical impedance spectroscopy. For example, Au contacts may be sputtered onto the top side of the LAPO film. The ionic conductivity (Tion) may be calculated using equation:

$${σ}_{ion} = \frac{l}{RA}$$

where R is the resistance of the bulk solid electrolyte, A is the area of the electrical contacts on the top side (i.e. the side facing away from the silicone substrate) of the film and/is the thickness of the LAPO film.

The temperature dependence of the ionic conductivity follows an Arrhenius behaviour described by the equation:

$${σ}_{ion} T = {σ}_{T} {e}^{- \frac{{E}_{a}}{k T}}$$

where σ_{T}, is a pre-exponential factor dependent on temperature, k is the Boltzmann constant, T is the temperature, and Eₐ is the ionic conductivity activation energy. Eₐ may be determined from the gradient of a linear fit of a plot of the natural logarithm of σᵢₒₙT (ln(σᵢₒₙT)) (measured at a plurality of different temperatures) against 1/T, as described in section 5.3 of Classical and Emerging Characterization Techniques for Investigation of Ion Transport Mechanisms in Crystalline Fast Ionic Conductors, Chem. Rev. 2020, 120, 5954-6008. A lower activation energy is generally preferable as this results in faster diffusion of Li ions and therefore a higher ionic conductivity at any given temperature. The ionic conductivity activation energy of the LAPO solid electrolyte films of the invention may be less than 0.6 eV, preferably less than 0.5 eV, even more preferably less than 0.45 eV.

The films formed by the method of the invention also have an electronic conductivity on the order of ≈10⁻¹²10⁻¹³ S cm⁻¹ when measured at room temperature (i.e. 25° C.), which is approximately five orders of magnitude lower than the ionic conductivity of the films and compares well to that of LiPON. The electronic conductivities may be measured using a direct current, and may therefore be referred to as DC electronic conductivities. The low electronic conductivity of the LAPO films means that the transference number is ˜1 and is suggestive of stable cycling when used as a solid electrolyte, thereby preventing dendrite formation.

### Examples

### Methods

### Film Fabrication

LAPO thin films were synthesised by spin coating aqueous precursor solutions on a silicone substrate, followed by an annealing step in air. First, 50 mmol of Al(NO₃)₃·9H₂O was added to 50 mL deionised (DI) water and stirred for an hour until completely dissolved. To this solution, 63 mmol of H₃PO₄ (85% concentration by weight with water) was added and stirred overnight at 80° C. After the solution had been cooled to room temperature, 137.5 mmol of LiNO₃ was added. Finally, the solution was diluted with DI water to achieve a final concentration of 0.4 M with respect to Al and the solution allowed to dissolve for ˜ 10 minutes. The amount (i.e. moles) of LiNO₃ and H₃PO₄ added to the precursor solution was varied to achieve a range of Li:Al and P:Al molar ratios in the precursor solution as required.

Silicon (Si) substrates (p-type, boron-doped, single-side polished, resistivity <_{0.1} Ohm-cm, PI-KEM), were used as an electrically conductive back contact and as the substrate upon which the precursor solution was deposited. The Si substrates were cut into 2 cm×2 cm squares using a diamond scribe and sonicated in acetone and IPA separately for 5 minutes in each, rinsing with DI water in between. The substrates were then dried using an N₂ gun before being treated by oxygen plasma cleaning at 100 Watts (maximum power) for 5 min in pure O₂ gas to produce a hydrophilic surface.

The precursor solution was sonicated at 40° C. for an hour and cooled to room temperature before being twice filtered using a 0.2 μm Teflon syringe filter. The precursor solution was flooded onto the substrate and spin coated at 3000 rpm for 30 s (after a ramp rate of 6000 rpm/s) and immediately afterwards transferred to a pre-heated hot plate at 275° C. for 1 minute to cure the spin coated film. In some examples, the process of depositing the precursor solution, spin coating, and curing was repeated to form a multi-layer film, allowing the spin coated film to cool to room temperature after curing before depositing and spin coating the next layer. After the designated number of layers were spin coated on the substrate, a final anneal at a selected temperature (230° C., 275° C., 350° C., 400° C. or 500° C.) was carried out for 1 hour. When annealing at 350° C., 400° C. and 500° C. the final anneal took place in a box furnace with 5° C. min⁻¹ ramp rate. When annealing at 230° C. and 275° C. the annealing was performed on the hot plate. For the films annealed at 230° C., the curing step on the pre-heated hot plate took place at 230° C. so that the films were never exposed to a temperature above this value.

### Physical Characterisation

Film thickness was determined using a LEO Gemini 1525 field emission scanning electron microscope (SEM). A cross-sectional image of the film was prepared using the brittle-fracture method, sputtering a thin Au layer onto the film to ensure charging did not occur. The film morphology and mechanical properties were characterised using atomic force microscopy (AFM) (Bruker Dimension Icon with ScanAsyst) across a 10 μm×10 μm film area with the average roughness calculated from 3 different film areas. PeakForce tapping mode was adopted in all the AFM imaging with an RTESPA-525 silicon probe with reflective Al coating (Bruker Corp., k=200 N m⁻¹, f0=525 kHz). For precise measurements of the mechanical properties, the probe was calibrated by the relative method, using a standard HOPG (modulus 18 GPa) for reference. Alongside the morphology, at each point in the scan, the probe performs nanoindentation mechanical measurements and records the load and displacement of the specialized tips and cantilevers to produce load-displacement curve. This curve was further used to calculate the elastic modulus of the materials, by fitting to the DMT (Derjagin, Muller, Toropov) model. All of the results obtained by the AFM were analysed by Nanoscope Analysis software.

### Chemical Characterisation

Film composition was determined using X-ray photoelectron spectroscopy (K-alpha XPS system, Al source) with binding energies referenced against the adventitious carbon Is peak at 284.4 eV. A survey scan and regions around elements of interest were conducted. CasaXPS software was used to analyse the XPS data and quantify the chemical composition using Shirley background fitting.

Film structure was determined using grazing incidence X-ray diffraction (Bruker D8 Discover) with 50 W microfocus Cu source, to highlight any Bragg peaks. The scan was theta-theta with ×4 frames at 120 s per frame and the sample was rotated in the beam. The Cu source was used with a Vantec 500 2D detector with the first frame set at 15° 2(θ) and the last at 56°. For the SEM and XPS measurements the films were all sintered at 275° C.

### Electrical Characterisation

Through-plane conductivity measurements were performed on the films to measure the ionic conductivity of Li⁺ ions moving through the solid electrolyte film during cell cycling. Circular (1.2 mm diameter) Au contacts (thickness ˜80 nm) were deposited onto the top surface of the film by sputtering through a shadow mask. For the bottom contact, Al foil was attached to the back of the Si substrate using conductive silver epoxy paste (Agar Scientific). An in-house cell holder was designed to take through-plane conductivity measurements in which an Au screw with a rounded tip was used to gently contact the top Au sputtered electrode. The Au screw and Al back contact were connected to a potentiostat (Reference 600+, Gamry) for electrochemical measurements. Electrochemical impedance spectroscopy (EIS) was conducted using a 5 mV perturbation voltage over a frequency range of 50 Hz to 1 MHz. The EIS data was fitted using an equivalent circuit model (ECM) comprising of elementary components in a Randles' type circuit. A resistor (R) and constant phase element (CPE) in parallel were used to model different time processes, where R₁ accounts for impedance due to noise from electrical contacts, R_{b} the bulk solid electrolyte impedance of LAPO and CPE_{w} to account for the electrode polarization due to the non-symmetric blocking electrodes (see Vadhva et al., Electrochemical Impedance Spectroscopy for All-Solid-State Batteries: Theory. Methods and Future Outlook; ChemElectroChem [Internet]. 2021 Jun. 1).

The ionic conductivity was calculated using equation:

$${σ}_{ion} = \frac{l}{RA}$$

where R is the resistance of the bulk solid electrolyte, A is the area of the top Au contacts and/is the thickness of the film. The σᵢₒₙ value was averaged from 3 different films, with each film being sampled in multiple positions (>3) across the film.

The ionic conductivity of an LAPO film synthesised using a molar ratio of Li:Al of 2.75:1 and annealed at 275° C. was measured at six temperatures. The ionic conductivity activation energy was determined from a linear fit of a plot of the natural logarithm of the product of the measured ionic conductivities and T (ln(σᵢₒₙT) against 1/T (see FIG. 9). The activation energy was determined to be 0.42 eV.

To quantify the electronic conductivity of the LAPO films, a voltage bias of 1 V was applied across the film, the steady-state current achieved after 1 hr measured, and the current-voltage curve fit to an exponential decay (see Han et al., High electronic conductivity as the origin of lithium dendrite formation within solid electrolytes: Nat Energy. 2019 Mar. 1; 4 (3): 187-96). A longer duration constant-voltage experiment was run over 12 hrs, which confirmed that 1 hr was sufficient to reach steady state.

### Results

### Morphology

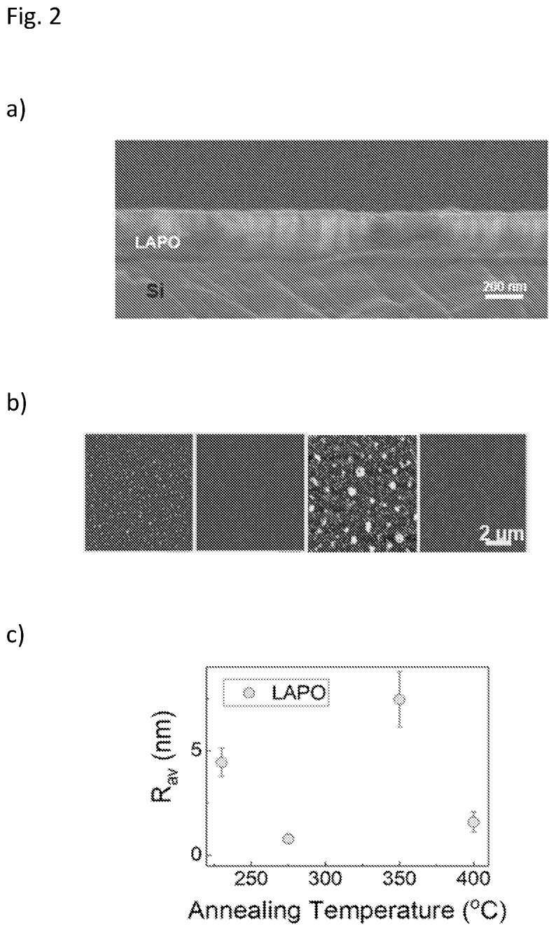

The SEM images show a dense film. Multi-layer LAPO films appear as a single continuous film with a thickness of approx. 300 nm, as shown in FIG. 2a. AFM was used to determine film morphology as a function of annealing temperature for single layer films. All exhibited Rₐ (average roughness)<10 nm (FIGS. 2b and 2c), with the film annealed at 275° C. having the lowest Rₐ of ≈1 nm which was targeted for electrical measurements. The Young's modulus of LAPO annealed at 275° C. was determined by AFM to be 54±4 GPa, which is much higher than soft sulfide SEs (≈15-20 GPa) and close to LiPON (77 GPa), suggestive of being sufficiently tough to supress dendrite propagation.

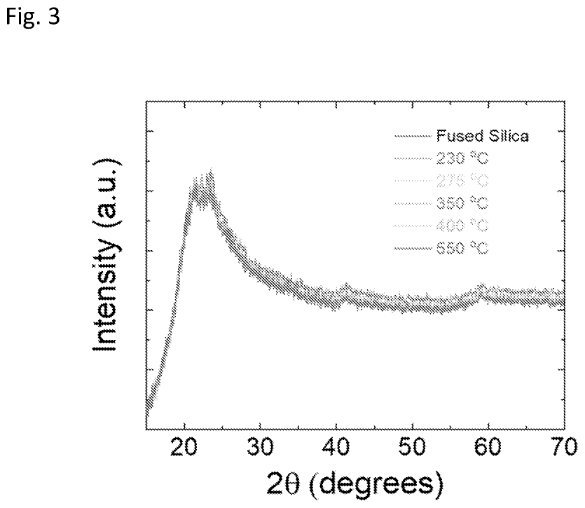

Structure XRD on the multi-layer LAPO films showed no evidence of Bragg peaks compared with the fused silica substrate, indicating the films are either fully amorphous or display short range order too small to be detected using the theta-theta lab XRD (see FIG. 3).

### Chemical Composition

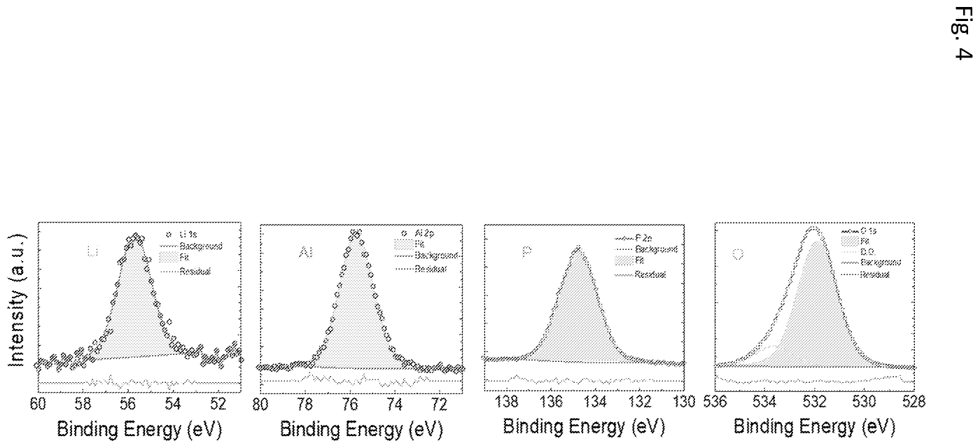

Different XPS region scans for LAPO films synthesised using a precursor solution having a Li:Al ratio of 2.75:1 and a P:Al ratio of 1.25:1 are shown in FIG. 4. The Li region scan clearly detected a Li₂O environment. The oxygen environments relating to Al₂O₃ is captured, and a defect oxygen peak is also seen. Phosphorous is in its P 2p state while the Al 2p scan clearly shows Al in Al₂O₃ environment.

Table 1 depicts the composition of LAPO films synthesised using a precursor solution having a Li:Al ratio of 2.75:1 and a P:Al ratio of 1.25:1 annealed at different temperatures. The Li stoichiometry standard deviation was <5%. These XPS data demonstrate a Li:Al ratio in the final films in the region of 2.75:1, which is representative of the Li:Al ratio in the precursor solutions.

TABLE 1
LAPO film composition determined by XPS at different annealing
temperatures following film synthesis with precursor solutions
having a Li:Al ratio of 2.75:1 and a P:Al ratio of 1.25:1.

| | |
|---|---|
| Annealing | |
| Temperature | Stoichiometry of LiₐAl_{b}P_{c}Oₓ |

| (° C.) | a | b | c | x |
|---|---|---|---|---|
| 230 | 3 | 1 | 1.4 | 5.2 |
| 275 | 2.8 | 1 | 1.3 | 5.1 |
| 350 | 2.7 | 1 | 1.3 | 5.2 |
| 400 | 2.9 | 1 | 1.2 | 5.6 |

### Effect of Li Content on Ionic Conductivity

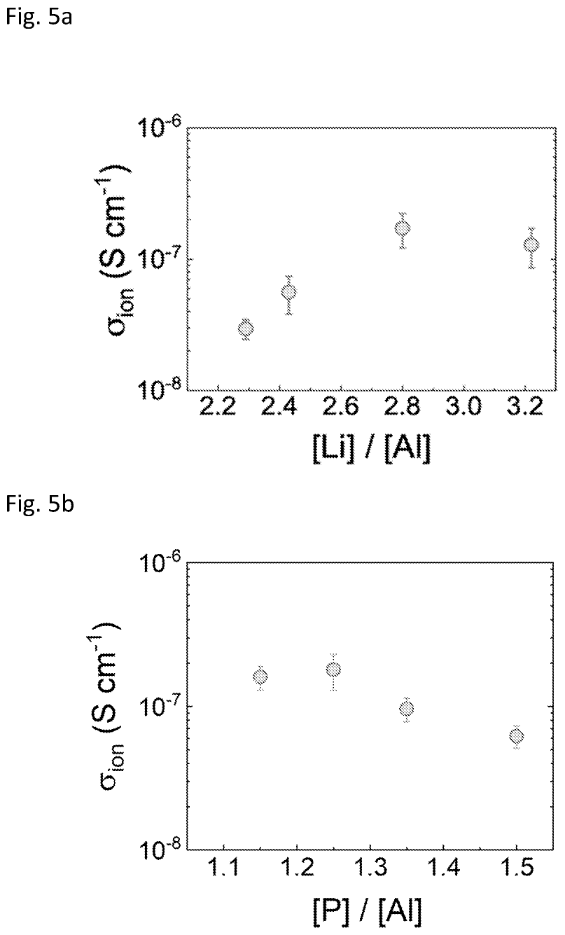

The relationship between the Li:Al molar ratio in the synthesised films (as measured by XPS) and the measured ionic conductivity is shown in FIG. 5a. All films in FIG. 5a were annealed at 275° C. The molar ratios of Li:Al in the precursor solutions used to synthesise the films are provided in Table 2. The molar ratio of P:Al in the precursor solution was 1.25:1 for all films.

TABLE 2

| Li:Al ratio in final film | Li:Al ratio in precursor |
|---|---|
| determined from XPS | solution |
| 2.3 | 3.025 |
| 2.45 | 2.475 |
| 2.8 | 2.75 |
| 3.2 | 2.8875 |

As the Li:Al molar ratio in the film increases the ionic conductivity also increases, peaking at a Li:Al molar ratio of around 2.8:1 in the final film (corresponding to a Li:Al molar ratio of 2.75:1 in the precursor solution). As the Li:Al molar ratio in the film increases to 3.2:1 (corresponding to a Li:Al molar ratio of 2.8875:1 in the precursor solution) there is a slight fall off in ionic conductivity, although the measured ionic conductivity at these higher values is still very good and an improvement on lower Li:Al molar ratios below 2.6:1. When the molar ratio of Li:Al in the precursor solution is increased still further to 3.025:1 the Li:Al ratio in the final film counterintuitively reduces to 2.3:1 due lithium not being incorporated into the LAPO film as readily and the film failing to spin coat onto the substrate as well.

### Effect of Phosphate Content on Ionic Conductivity

The relationship between the P:Al molar ratio in the precursor solution and the measured ionic conductivity is shown in FIG. 5b. All films in FIG. 5b were annealed at 275° C. The molar ratios of Li:Al in the precursor solutions used to synthesise the films was 2.75:1 for all films. The P:Al ratio in the final films can be assumed to be equivalent to the P:Al ratio in the precursor solutions because phosphate, which is the form in which the phosphorus is present, is not particularly volatile and is therefore expected to be incorporated into the final film in the amounts present in the precursor solution.

As the P:Al molar ratio in the precursor solution is decreased from 1.5:1 the ionic conductivity increases, peaking at a P:Al molar ratio of around 1.25:1. As the P:Al molar ratio decreases to 1.15:1 there is a slight fall in the ionic conductivity, although the measured ionic conductivity at these higher values is still very good and an improvement on higher P:Al molar ratios above 1.3:1.

### Effect of Annealing Temperature on Ionic Conductivity

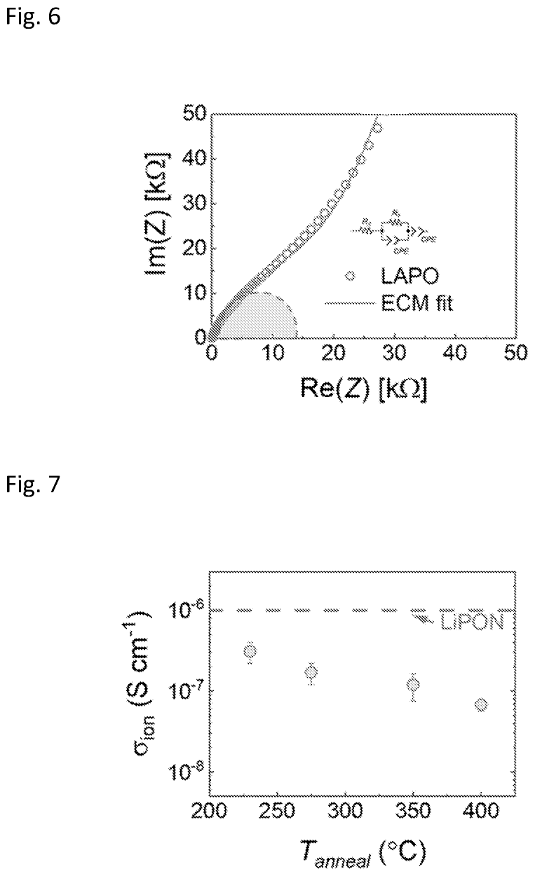

From the results shown in FIG. 5, the optimal ionic conductivity Li:Al molar ratio of 2.8:1 was selected (corresponding to a Li:Al molar ratio in the precursor solution of 2.75:1) and the ionic conductivity as a function of annealing temperature investigated. An inverse relationship between the annealing temperature and ionic conductivity was observed (FIG. 7), with the highest conductivity film being annealed at the lowest annealing temperature (230° C.). The ECM and fit are shown for the 275° C. film (FIG. 6). The results therefore demonstrate that annealing at temperatures below 250° C., e.g. at 230° C. results in LAPO films having an improved ionic conductivity. The reduction in ionic conductivity as a function of annealing temperature suggests that as the LAPO films tend toward higher crystallinity when annealed at higher temperatures their conductivity pathways are reduced.

### Electronic Conductivity

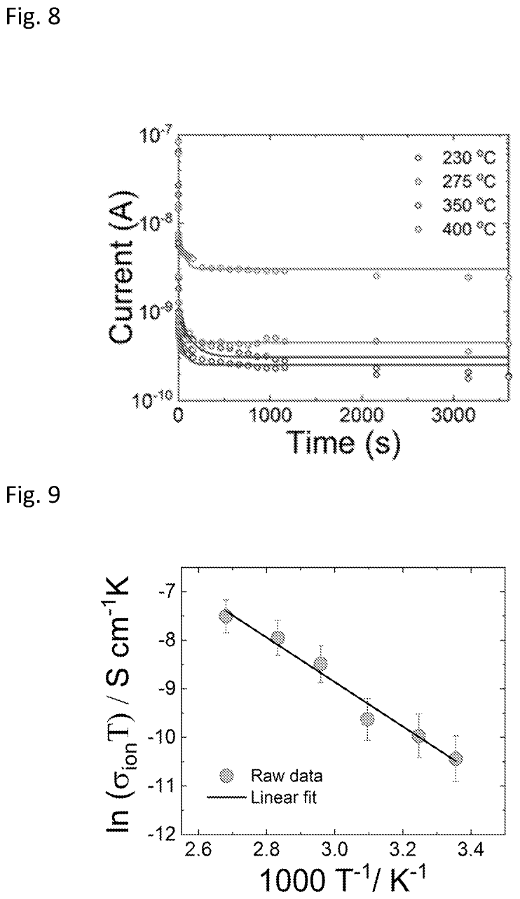

The current decay of the LAPO films of Table 1 over 1 hour to reach steady state is shown in FIG. 8. From the steady-state current value, the electronic conductivity is calculated on the order of 10⁻¹²-10⁻¹³ S cm⁻¹ (FIG. 7 b) for these films, which is approx. 5 orders of magnitude lower than the ionic conductivity of the films and compares well to that of LiPON (≈10⁻¹²-10⁻¹⁵ S cm⁻¹). The low electronic conductivity of LAPO means that the transference number is ˜1 and the very low electronic conductivity is suggestive of stable cycling when used as a solid electrolyte, thereby preventing dendrite formation.

1. A method for forming a lithium aluminum oxide phosphate (LAPO) solid electrolyte film, the method comprising:
depositing an aqueous precursor solution onto a substrate to form a deposited film; and
annealing the deposited film to form the LAPO solid electrolyte film;
wherein the precursor solution contains lithium and aluminum in a molar ratio of at least 2.6:1.

2. The method of claim 1, wherein the precursor solution contains lithium and aluminum in a molar ratio of no greater than 2.9:1.

3. The method of claim 2, wherein the precursor solution contains lithium and aluminum in a molar ratio within the range of 2.6:1 to 2.9:1.

4. The method of claim 1, wherein the precursor solution contains phosphate and aluminum in a molar ratio of 1.40:1 or less.

5. The method of claim 1, wherein the precursor solution contains phosphate and aluminum in a molar ratio of at least 1.10:1.

6. The method of claim 1, wherein the annealing of the deposited film is carried out at a temperature of less than 250° C.

7. The method of claim 1, wherein the annealing of the deposited film is carried out at a temperature of at least 220° C.

8. The method of claim 1, wherein the aqueous precursor solution comprises aluminum nitrate and/or aluminum hydroxide.

9. The method of claim 1, wherein the aqueous precursor solution comprises lithium nitrate.

10. The method of claim 1, wherein the aqueous precursor solution comprises phosphoric acid.

11. The method of claim 1, further comprising curing the deposited film by heating the deposited film prior to annealing the deposited film.

12. The method of claim 11, wherein the temperature to which the deposited film is heated during the curing is less than 250° C.

13-15. (canceled)

16. The method claim 1, wherein the LAPO solid electrolyte film contains lithium and aluminum in a molar ratio of at least 2.6:1.

17. (canceled)

18. The method of claim 1, wherein the LAPO solid electrolyte film contains phosphate and aluminum in a molar ratio of 1.40:1 or less.

19-20. (canceled)

21. A lithium aluminum oxide phosphate (LAPO) solid electrolyte film containing lithium and aluminum in a molar ratio of at least 2.6:1, wherein the LAPO solid electrolyte film is obtained by the method of claim 1.

22. A LAPO solid electrolyte film containing lithium and aluminum in a molar ratio of at least 2.6:1.

23. The LAPO solid electrolyte film of claim 22, wherein the LAPO solid electrolyte film contains phosphate and aluminum in a molar ratio of 1.40 or less.

24. A battery comprising a lithium aluminum oxide phosphate (LAPO) solid electrolyte film in accordance with claim 22.

25. The battery of claim 24, wherein the battery is a solid-state battery.

26. The LAPO solid electrolyte film of claim 22, wherein the LAPO solid electrolyte film has a thickness of 1 μm or less.
